(19) United States
(12) Patent Application Publication
(10) Pub. No.: US 2010/0154126 A1
(43) Pub. Date: Jun. 24, 2010

(54) BED FOR NURSING

(76) Inventor: Xiading WANG, Fuzhou (CN)

Correspondence Address: MATTHIAS SCHOLL, 14781 MEMORIAL DRIVE, SUITE 1319, HOUSTON, TX, 77079, US

(21) Appl. No.: 12/634,066

(22) Filed: Dec. 9, 2009

Related U.S. Application Data
(63) Continuation of application No. 10/568,245, filed on Feb. 14, 2006, now abandoned.

(30) Foreign Application Priority Data
Aug. 16, 2003 (CN) 03271456.4

(51) Int. Cl. A61G 7/00; A47C 17/86

(52) U.S. Cl. 5/724

(57) ABSTRACT

A healthy bed for nursing characterized in that 1) a bed body of the healthy bed for nursing is a single layer of sheet fabric with a mesh opening by interweaving a warp and a weft in a vertical direction and equidistantly; 2) a interweaving point of the warp and the weft is fastened by a fixed connection; 3) a diameter or diagonal length of the mesh opening is more than or equal to a diameter of the warp and the weft and less than 30 times the diameter of the warp and the weft; and 4) both the warp and the weft are a waterproof artificial fiber or plant fiber pretreated with a waterproof adhesive on its surface or inside. The healthy bed for nursing has simple structure and low cost, and is healthy and easy to clean.

### CROSS-REFERENCE TO RELATED APPLICATIONS

This application is a continuation of U.S. Ser. No 10/568,245 filed on Feb. 14, 2006, now pending, which is a National Stage Application of International Patent Application No. PCT/CN2004/000934, with an international filing date of Aug. 12, 2004, which is based on Chinese Patent Application No. 03271456.4, filed Aug. 16, 2003. The contents of all of these specifications are incorporated herein by reference in their entirety.

### BACKGROUND OF THE INVENTION

1. Field of the Invention

The invention relates to a healthy bed for nursing for babies or bedridden patients.

2. Description of the Related Art

Conventional healthy beds for nursing for babies or patients who are confined to beds have a complicated structure and high cost, which means a limited application scope. U.S. Pat. No. 6,274,520 discloses a nursing bed composed of a multi-layered fabric, however the multi-layered fabric will block the flow of water during washing and even cause pollutant and bacteria accumulation. U.S. Pat. No. 4,052,243 discloses a reticular material constructed from warps and wefts. However, the warps and wefts are formed respectively in different plane, and then fastened and coated with a glue. It is obvious that when uneven load occurs, the warp plane and the weft plane will be parted due to the limited adhesion of the glue.

Further, the size of the mesh opening of the reticular structure for a nursing bed in prior art and the diameter of the warps and wefts are relatively big, which will press skin and not benefit for nutrient supply and excretion release.

### SUMMARY OF THE INVENTION

In view of the above-described problems, it is one objective of the invention to provide a healthy bed for nursing that has low cost and is easy to clean.

To achieve the above objectives, in accordance with one embodiment of the invention, there is provided a healthy bed for nursing that has low cost and is easy to clean, the healthy bed for nursing characterized in that
1) a bed body of the healthy bed for nursing is a single layer of sheet fabric with a mesh opening by interweaving a warp and a weft in a vertical direction and equidistantly;
2) a interweaving point of the warp and the weft is fastened by a fixed connection;
3) a diameter or diagonal length of the mesh opening is more than or equal to a diameter of the warp and the weft and less than 30 times the diameter of the warp and the weft; and
4) both the warp and the weft are a waterproof artificial fiber or plant fiber pretreated with a waterproof adhesive on its surface or inside.

In a class of this embodiment, a diameter of the warp and the weft is less than 0.08 mm.

In a class of this embodiment, a diameter of the warp and the weft is 0.06 mm.

In the invention, the bed body is a single layer of sheet fabric having mesh openings by interweaving the warp and the weft in a vertical direction and equidistantly. The four sides of the sheet fabric are fixed to the bed frame and thereby the body weight of a patient is shouldered by the bed frame, which means the fabric should have a good tensile strength.

The interweaving point of the warps and the wefts is fastened by a fixed connection, which ensures a uniform force upon loading and thereby leads to an increased tensile strength. So, the diameter of the warps and the wefts can be relatively much smaller. The warps and wefts with small diameter relieve the pressure on skin and are beneficial for nutrient supply and excretion release.

The advantages of the invention are summarized below: simple structure, low cost, easy to clean, and healthy.

### BRIEF DESCRIPTION OF THE DRAWINGS

The invention is described hereinbelow with reference to accompanying drawings, in which:

FIG. 1 is a schematic diagram of a warp plane parting with a weft plane due to uneven load and limited adhesion of glue of a nursing bed;

FIG. 2 is a schematic diagram of a healthy bed for nursing according to one embodiment of the invention;

FIG. 3 is an enlarged view of structure I of FIG. 2; and

FIG. 4 is a schematic diagram of cleaning a healthy bed for nursing according to one embodiment of the invention.

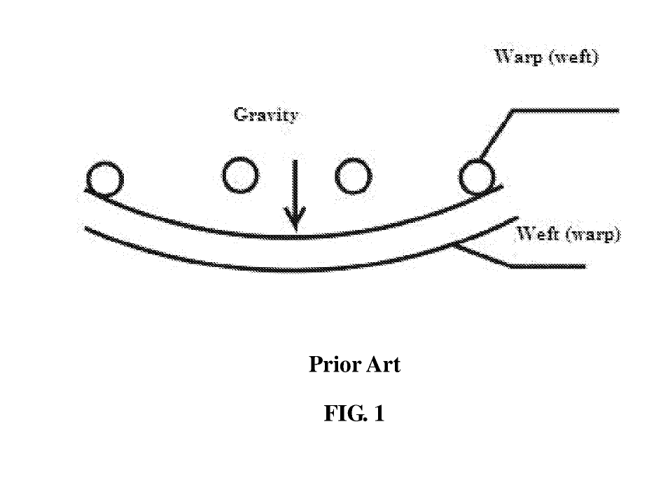

### DETAILED DESCRIPTION OF THE EMBODIMENTS

For further illustrating the invention, experiments detailing a healthy bed for nursing are described below. It should be noted that the following examples are intended to describe and not to limit the invention.

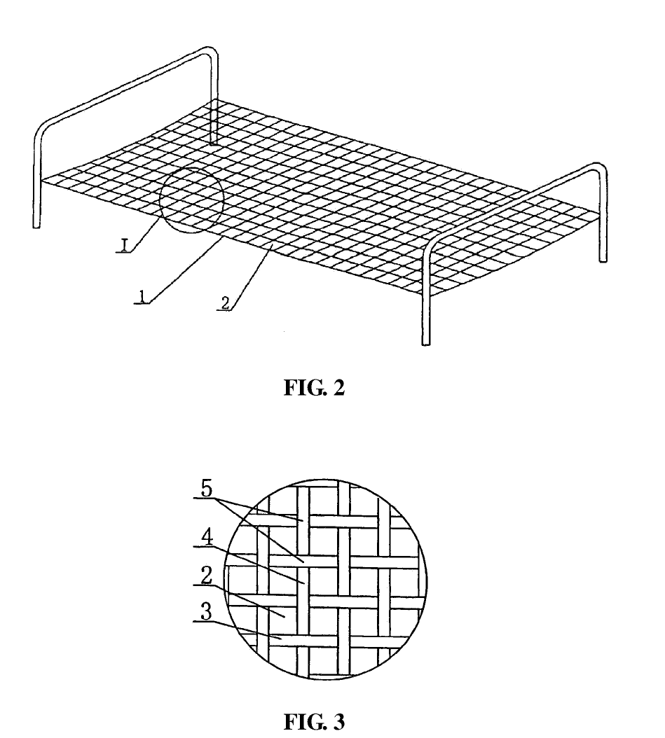

As shown in FIGS. 2 and 3, a healthy bed for nursing, characterized in that
1) a bed body 1 of the healthy bed for nursing is a single layer of sheet fabric with a mesh opening 2 by interweaving a warp 3 and a weft 4 in a vertical direction and equidistantly;
2) a interweaving point 5 of the warp 3 and a weft 4 is fastened by a fixed connection;
3) a diameter or diagonal length of the mesh opening is more than or equal to a diameter of the warp 3 and a weft 4 and less than 30 times the diameter of the warp 3 and a weft 4; and
4) both the warp 3 and a weft 4 are a waterproof artificial fiber or plant fiber pretreated with a waterproof adhesive on its surface or inside.

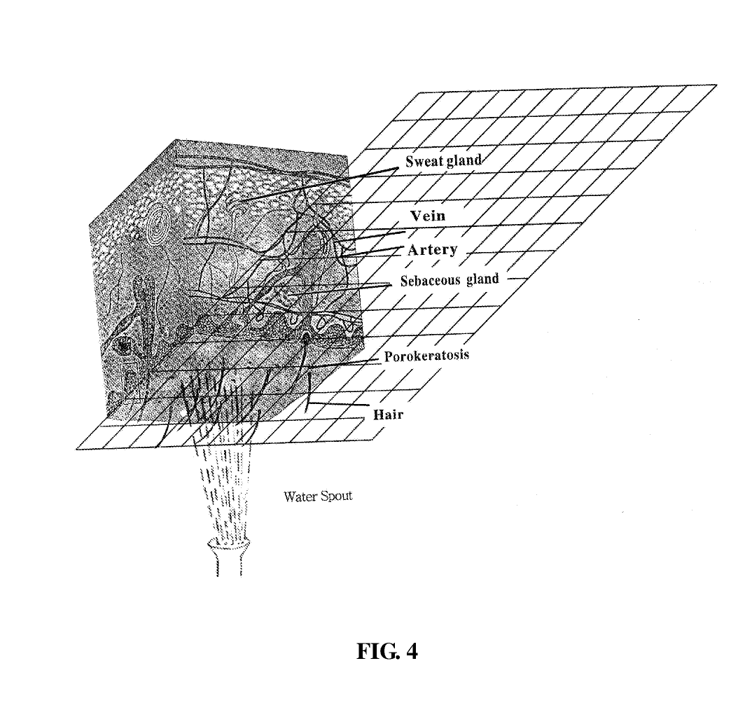

Particularly, the diameter of the warp 3 and a weft 4 is less than 8 mm, and more particularly is 0.06 mm. The perimeter of the mesh opening 2 is 0.27 mm. The ratio of the total area of the warp 3 and a weft 4 to the area of the mesh opening 2 is 1:4, and thereby the mesh opening 2 takes up 80% of the total area of the bed. The distribution rate of mesh opening 2 is between 9 and 10 per mm², so there are almost 1,000 mesh openings 2 per cm². All these are beneficial for air and water flow and cleaning the bed even without removing a patient (as shown in FIG. 4).

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A bed comprising a bed body, wherein
said bed body is a single layer of sheet fabric with a mesh opening;
said bed body comprises a warp and a weft interwoven in a vertical direction equidistantly;
an interweaving point of said warp and said weft is fastened by a fixed connection;
the diameter or diagonal length of said mesh opening is more than or equal to a diameter of said warp and said weft and less than 30 times the diameter of said warp and said weft; and
said warp and said weft comprise waterproof artificial fiber or plant fiber pretreated with a waterproof adhesive.

2. The bed of claim 1, wherein the diameter of said warp is less than 0.08 mm and the diameter of said weft is less than 0.08 mm.

3. The bed of claim 2, wherein the diameter of said warp is 0.06 mm and the diameter of said weft is 0.06 mm.
